(19) United States
(12) Patent Application Publication
(10) Pub. No.: US 2026/0141046 A1
(43) Pub. Date: May 21, 2026

(54) RADIO FREQUENCY IDENTIFICATION ("RFID") TAGS USED AS AN APPLICATION TOKEN

(71) Applicant: Bank of America Corporation, Charlotte, NC (US)

(72) Inventors: Patricia Anne Gillis, Chicago, IL (US); Thomas J. Durkin, Chicago, IL (US)

(21) Appl. No.: 18/955,114

(22) Filed: Nov. 21, 2024

(51) Int. Cl. G06F 21/35; G06F 21/32; G06K 7/10

(52) U.S. Cl. CPC G06F 21/35; G06F 21/32; G06K 7/10297

(57) ABSTRACT

A system may be used for authenticating a user using a two-step authentication process. The system may be operable to receive a request from a user’s mobile device to authenticate into the system. The system may receive a first step authentication including a radio-frequency identification (“RFID”) tag. The system may receive a second step authentication. The system may determine a predetermined level of authentication for the user. When the first step authentication and the second step authentication achieve a predetermined level of authentication, the user may be authenticated. When the first step authentication and the second step authentication are less than a predetermined level of authentication, the user may be denied access to the system.

### FIELD OF TECHNOLOGY

Aspects of the disclosure relate to authentication and authorization. Specifically, the disclosure relates to authentication and authorization using radio frequency identification (“RFID”) tags.

### BACKGROUND OF THE DISCLOSURE

Mobile applications (“apps”) have become a part of everyday life. Mobile apps are used for banking, shopping, currency-exchange and a plurality of other purposes. Online banking apps have become a venue in which customers easily access bank accounts.

However, with the increase of the usage of digital banking, users of malicious intent may attempt to access secure digital banking systems. Users of malicious intent may retrieve passwords used to access the digital banking systems through various retrieval and interception methods. Various retrieval and interception methods include retrieving passwords as the user types the password, retrieving passwords stored on the user’s mobile device and/or any other suitable methods of retrieving the password. Therefore, online banking systems, as well as other secure systems, require systems that enable users to access the secure systems, without compromising the security of the authentication information, such as passwords.

It would be desirable to create systems and methods that increase security of digital systems.

It would be further desirable to create methods and systems in which the user authenticates into a system using a token. As such, only a user with the token can authenticate thereby accessing the system.

It would be further desirable for systems to use physical RFID tags as physical tokens to authenticate into the system.

### SUMMARY OF THE DISCLOSURE

Apparatus, methods and systems for Radio Frequency Identification (“RFID”) tags used as an application token are provided.

Methods may include receiving a request from a user to authenticate into a system or application. The user may have previously accessed the system. As such, the request may be a subsequent request received from the user. Such a user may be termed a subsequent user. In such an embodiment, the subsequent user may authenticate into the system and verify credentials previously stored in the system.

The request may be an initial request received from a/the user. As such, the user may be an initial user. The user may log in, enter credentials and/or create an account when the user authenticates into a system or application for the first time.

During an initial request or a subsequent request the user may input a request to authenticate into the system or application. The request may include a username, a password and/or any other suitable request input. The request may include a username and/or password that have been previously input into the system. The request may be received from a user’s device and/or any other suitable device. A user’s device may include a mobile device, a computer, a smartwatch, a smartphone and/or any other suitable device. When the system receives the request including the username and password, the system may retrieve the username, password and/or other verification information stored in the system that has been previously associated with the user. Upon receiving the request input and/or other associated credentials, the system may verify the user on a first verification level.

The first verification level may include a comparison of previously stored credentials to the credentials input with the request. The previously stored credentials and the input credentials may be similar over a first level of similarity. The first verification level may include a confidence in the identity of the user of over 90%, 95%, 100% or any other suitable percentage. As such, when the input credentials match the stored credentials associated with the user, the user may be verified on an initial, or first, level. It should be noted that upon successful verification at the first level, the user may be verified on one or more subsequent levels. Upon verification at each of the levels, the user may be authenticated. It should be noted that the number of levels a user may be verified at may be different for each user.

Upon verification at the first level, the system executables may prompt the user to select one or more of a plurality of actions. The plurality of actions may be a collection of actions commonly performed by a user when logging into the system. The plurality of actions may be a collection of actions that the user has performed when previously interacting with the system. The plurality of actions may include a deposit, a transfer, a purchase and/or any other suitable actions. The user may select one or more actions from the plurality of actions. Such a process in which the user selects an action may be referred to as an action selection process.

Upon completion of verification at the first level, methods may include transmitting a request for a scan of a radio-frequency identification (“RFID”) tag from the system or application to the user’s mobile device. The RFID tag scan may be used to verify the user on a second level. RFID tags, for the purposes of the application, include a tiny radio transmitter, a radio receiver and a transmitter. The RFID tag may be triggered by an electromagnetic interrogation pulse from a nearby RFID reader. In response to the trigger, the RFID tag may transmit digital data to the reader. It should be noted that the RFID tag reader may be a user’s mobile device and/or any other suitable RFID tag reader.

Methods may include transmitting the RFID tag scan to the system. The system, for the purposes of this application, may include a server, a database and/or any other suitable apparatus. The RFID tag may be permanently or portably located on a wallet, a desk, a keychain and/or any other suitable location associated with the user. The RFID tag reader may scan the RFID tag. The RFID tag scan may be transmitted to the system. The path between the system, the user and the system RFID tag may not operate on the same communication channels.

Methods may further include receiving the RFID tag scan at the system. Upon receipt of the scan, the system may determine if the RFID tag that generated the RFID tag scan matches the identity of a previously stored RFID tag associated with the user. If scanned RFID tag matches the stored RFID tag, the user may be verified at a second verification level.

The RFID tag may have been previously stored in the system as linked to the user. The RFID tag scan may verify that the user scanning the RFID tag is who the user purports to be because the user has verified possession of the RFID tag. Each user may have an RFID verification tag that, when scanned, verifies the user at the second verification level and/or any other suitable levels.

Methods may further include transmitting a request to the user’s mobile device for an input of a second step authentication. A second step authentication, for the purposes of the application, may include a biometric identification, a personal identification number (“PIN”) entry, a geographic (“geo”) location of the RFID tag and/or a geo location of the user’s mobile device, a scan of one or more additional RFID tags and/or any other suitable authentication.

A biometric identification may include a fingerprint of the user, a facial scan of the user, an iris scan of the suer, a retinal identification of the user, a keystroke model of the user, palm vein recognition of the user as well as any other suitable biometric identification.

The location of the user may be determined by a global positioning system (“GPS”) in the user’s mobile device. The location of the RFID tag may be determined by a GPS embedded in the RFID tag. In some embodiments, the mobile device may be electronically linked to the RFID tag. In such embodiments, the location of the RFID tag may be determined by a GPS embedded in the user’s mobile device.

It should be noted that a single RFID tag may be used to verify the user on multiple levels. The user may access different parts of the system based on the levels. The levels may be successfully verified with input of biometrics, PIN (personal identification number) entry and/or any other suitable authentication.

Each additional information element a user inputs may successfully verify the user on an additional level. A biometric input may allow the user to perform a transfer. A PIN entry may allow the user to perform a withdrawal. Any additional input may allow the user to perform any other suitable action.

In some embodiments, a user may be able to authenticate into specific levels. The user may be able to access different parts of the system depending on the level of the user. The system may determine the level of the user based on the RFID tag and associated authentication inputs.

In some embodiments, a user may have multiple RFID tags. Each RFID tag may be used as authentication for a specific action. There may be a transfer RFID tag, a deposit RFID tag, a purchase RFID tag and/or any other suitable RFID tag. As such, additional security may be used to authenticate the user. In such an embodiment, the second step authentication may include a request for a specific RFID tag scan.

A subsequent level authentication may be performed. Upon verification of the subsequent level and/or any other subsequent level, the user may perform the selected one or more actions. Upon selection of one or more actions, the system may determine an appropriate second step authentication. The second step authentication may include a scan of a radio frequency identification (“RFID”) tag, a biometric identifier, a PIN entry and/or any other suitable method of authentication.

A specific authentication may be required in accordance with the selected one or more actions. For example, a deposit may be verified using a deposit RFID tag. A transfer may be verified using a transfer RFID tag. A purchase may be verified using a purchase RFID tag. As such, the second level of authentication may be determined according to the one or more actions selected by the user.

In some embodiments, the subsequent verification level may be the same for each action. As such, a deposit, a transfer, a purchase and/or any other suitable actions may be verified using the same RFID tag. A user, in such an embodiment, may be a single RFID user. As such, security in addition to a password, may be provided.

In other embodiments, a single RFID tag may be used to verify multiple levels. A single RFID tag may be used in conjunction with biometrics, PIN entries and/or any other suitable authentication steps. The RFID tag may include multiple levels. A user may access different parts of the system based on the level successfully verified with the RFID tag. An iris scan may successfully verify one level, a PIN entry may successfully verify another level and/or any other biometric may successfully verify any other suitable level. The user may perform executables according to the levels of biometrics.

Methods may further include receiving, at the user’s mobile device, a second step authentication. The user may input a PIN, perform a biometric scan, scan a second RFID tag and/or any other suitable authentication. The user’s mobile device may receive the input of the second step authentication.

Methods may further include transmitting the second step authentication to the system. The second step authentication may be transmitted from the user’s mobile device to the system.

Methods may further include receiving, at the system, the second step authentication. Upon receiving the second step authentication, the system may perform a subsequent level verification. Upon the subsequent verification of the user, the user may perform the selected action. It should be noted that each second step authentication may have been previously input and stored in the system. When the user logged into the system an initial time, the system may have requested a series of biometric identifiers, a PIN and/or any other suitable identification steps. As such, when the user logs into the system any subsequent time, the system may verify the user using the previously stored information.

Methods may further include, upon receiving the second step authentication at the system, determining, at the system, if the first step authentication and the second step authentication successfully verify a predetermined level of authentication.

In some embodiments, the system may determine the validity of the first step authentication before requesting a selection of an action from the user. As such, the user may be validated multiple times. The system may validate the user on multiple levels. In other embodiments, the system may receive the first step authentication and the second step authentication before verifying the user. As such, the user may be verified one time. In such embodiments, the system may either verify the user or deny the user access to the system.

### BRIEF DESCRIPTION OF THE DRAWINGS

The objects and advantages of the invention may be apparent upon consideration of the following detailed description, taken in conjunction with the accompanying drawings, in which like reference characters refer to like parts throughout, and in which:

FIG. 1 shows an illustrative diagram in accordance with the principles of the disclosure;

FIG. 2 shows another illustrative diagram in accordance with the principles of the disclosure;

FIG. 3 shows an illustrative flow diagram in accordance with the principles of the disclosure;

FIG. 4 shows another illustrative flow diagram in accordance with the principles of the disclosure; and

FIG. 5 shows yet another illustrative flow diagram in accordance with the principles of the disclosure.

### DETAILED DESCRIPTION OF THE DISCLOSURE

Apparatus, methods and systems for Radio Frequency Identification (“RFID”) tags used as an authentication token are provided.

A user may authenticate into a system and/or application. The authentication may be a two-step authentication or any other suitable number of steps. The system may be an online banking system, an online shopping system or any other suitable system. The system may include a server, a database and/or any other suitable components.

The system may be operable to receive a request. The request may include a username and password. The request may include any other suitable information. The system and/or application may receive the request. The system may use the data included in the request to authenticate the user.

The system may be further operable to receive a first step authentication from the user. The first step authentication may be a scan of a radio frequency identification (“RFID”) tag. RFID tags, for the purposes of this application, include a tiny radio transmitter, a radio receiver and a transmitter. When triggered by an electromagnetic interrogation pulse from a nearby RFID reader, the tag transmits digital data back to the reader. The reader may be a user’s mobile device or any other suitable RFID reader.

The RFID tag can be portably or permanently attached to an object. For example, the RFID reader can be attached to a wallet, a card, a keychain, a desk and/or any other suitable geographic (“geo”) location. The RFID tag may be attached to a location near the user. As such, activities of malicious intent may be prevented.

In some embodiments, the system may receive a request from a user to perform an action. The user may select one or more actions from a plurality of actions. The system may include a collection of actions commonly performed by users. The user may select one or more actions from the collection of actions.

The system may be operable to receive a second step authentication. The second step authentication may be a scan of a second RFID tag, a biometric identifier, a PIN entry, a location of the user or any other suitable method of authentication. The second step authentication may be selected according to the one or more selected actions received from the user. In some embodiments, the second step authentication may be distinct from the action received by the user.

The system may be further operable to determine whether the first level authentication successfully verifies the user. When the first level authentication successfully verifies the user over a predetermined level of authentication, the system may determine whether the second level authentication successfully verifies the user over a predetermined level of authentication. It should be noted that in some embodiments, the predetermined level of authentication may be different for the first level authentication and the second level authentication.

The system may be further operable to determine if the first level authentication and the second level authentication successfully verify the user over a predetermined level of authentication. The predetermined level of authentication may be an authentication level of confidence of the identity of the user over a threshold of 60%, 65%, 70%, 75%, 80%, 85%, 90%, 95%, 100% or any other suitable percentage.

When the first level authentication and/or the second level authentication are determined to be over one or more predetermined levels of authentication, the user may be authenticated. Upon authenticating the user, the user may be enabled to perform one or more requested actions.

When the first level authentication and/or the second level authentication are determined to be less than the one or more predetermined levels of authentication, the system may deny the user access into the system.

Systems and methods described herein are illustrative. Systems and methods in accordance with this disclosure may now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

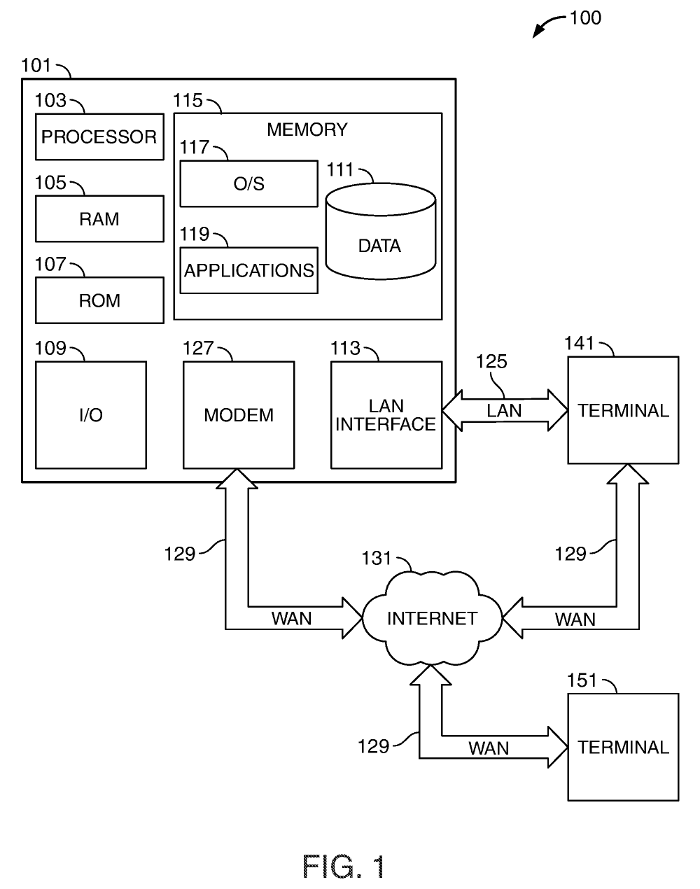

FIG. 1 shows an illustrative block diagram of apparatus 100 that includes computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/ microprocessors 103 for controlling the operation of the device and its associated components, and may include RAM 105, ROM 107, input/output module 109, and a memory 115. Microprocessors 103 may also execute all software running on the computer 101—e.g., the operating system 117 and applications 119 such as an artificial intelligence implemented termination program and security protocols. Other components commonly used for computers, such as EEPROM or Flash memory or any other suitable components, may also be part of the computer 101.

Memory 115 may be comprised of any suitable permanent storage technology—e.g., a hard drive or other non-transitory memory. ROM 107 and RAM 105 may be included as all or part of memory 115. The memory 115 may store software including the operating system 117 and application(s) 119 (such as an artificial intelligence implemented termination program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user’s local device. Cloud-based applications may be accessed via any type of internet connection (e.g., cellular or Wi-Fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an artificial intelligence implemented termination program and security protocols, as well as other programs. In an embodiment, one or more programs, or aspects of a program, may use one or more artificial intelligence/machine learning (“AI/ML”) algorithm(s). The various tasks may be related to terminating or preventing a malicious AI from completing its malicious activities.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

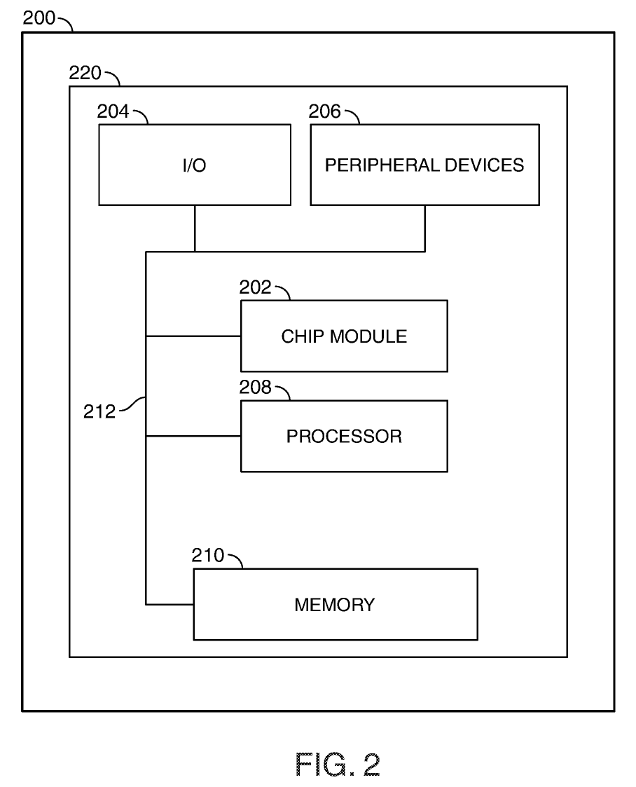

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-5. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

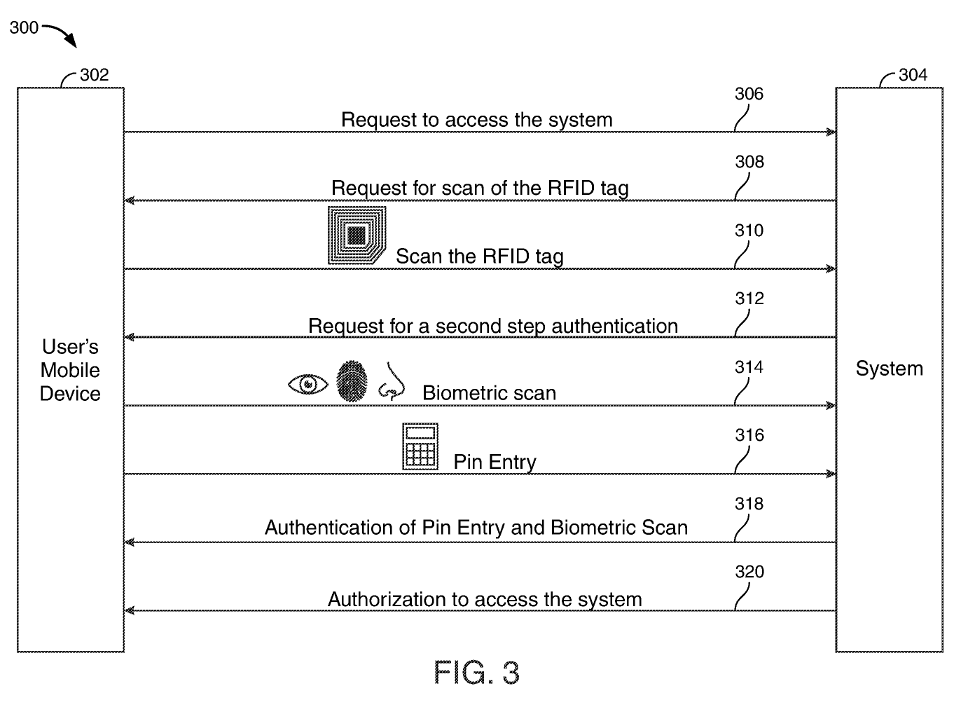

FIG. 3 shows diagram 300. User’s mobile device 302 may be used to access system 304. A user may transmit a request to access system 304 from user’s mobile device 302, as shown at step 306. The request may include a username, a password and/or any other suitable request input.

In response to receiving the request from the user, system 304 may transmit a request to user’s mobile device 302 for a scan of a radio-frequency identification (“RFID”) tag, as shown at step 308. The user may be verified on an initial level upon receiving the RFID tag scan. The RFID tag may be a physical tag located in close proximity to the user and/or user’s mobile device 302. The RFID tag may be located on a desk, keychain, phone cover, wallet or any other suitable location.

The user may scan an RFID tag using user’s mobile device 302. User’s mobile device 302 may transmit the RFID tag scan to system 304, as shown at step 310. In response to receiving the scan of the RFID tag, system 304 may transmit a request for a second step authentication, as shown at step 312.

User’s mobile device 302 may transmit either a biometric scan, as shown at step 314 and/or a PIN entry, as shown at step 316, to system 304. It should be noted that both the biometric scan and the PIN entry may be transmitted to system 304. Furthermore, any other suitable second step authentication, including those not shown, may be transmitted to system 304.

Upon receiving the biometric scan, PIN entry or any other suitable second step authentication, system 304 may transmit an authentication of the PIN entry and/or biometric scan to user’s mobile device 302, as shown at step 318. Upon authentication of the second step authentication, system 304 may transmit authentication to user’s mobile device 302, as shown at step 320. Upon authentication of the user, the requested action may be executed.

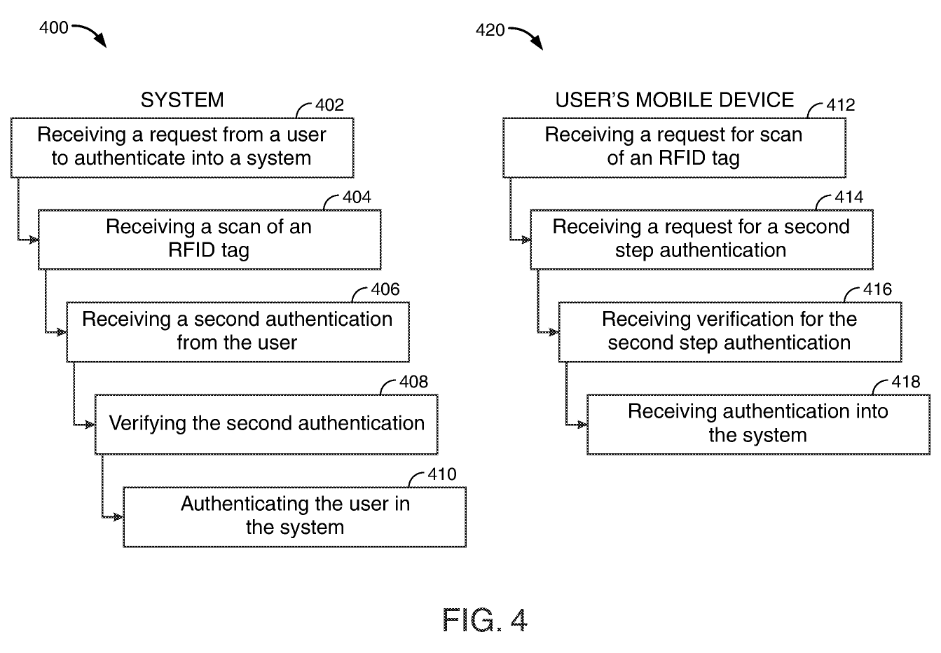

FIG. 4 shows illustrative flow diagram 400 and illustrative flow diagram 420. Flow diagram 400 is a diagram of the system authenticating a user. The system may receive a request from a user to authenticate into the system, as shown at step 402. The request may include a username, a password and/or any other suitable request input.

The system may receive a scan of an RFID tag, as shown at step 404. The RFID tag may verify the user over a first verification level. The system may receive a second authentication from the user, as shown at step 406. The second authentication may be a second RFID tag scan, a PIN entry, a biometric scan or any other suitable authentication. The system may verify the second authentication, as shown at step 408. Upon verifying the second authentication, the system may authenticate the user, as shown at step 410.

Flow diagram 420 is a diagram of the user’s mobile device when the user is authenticating into the system. The user’s mobile device may receive a request from the system for an RFID tag scan, as shown at step 412. In response to transmitting an RFID tag scan, the user’s mobile device may receive a request for a second step authentication, as shown at step 414. A second step authentication may include a biometric scan, a PIN entry, a second RFID tag scan from a subsequent RFID tag or any other suitable authentication. In response to transmitting a second step authentication, the user’s mobile device may receive verification for the second step authentication, as shown at step 416. The user’s mobile device may further be authenticated and allowed access into the system, as shown at step 418.

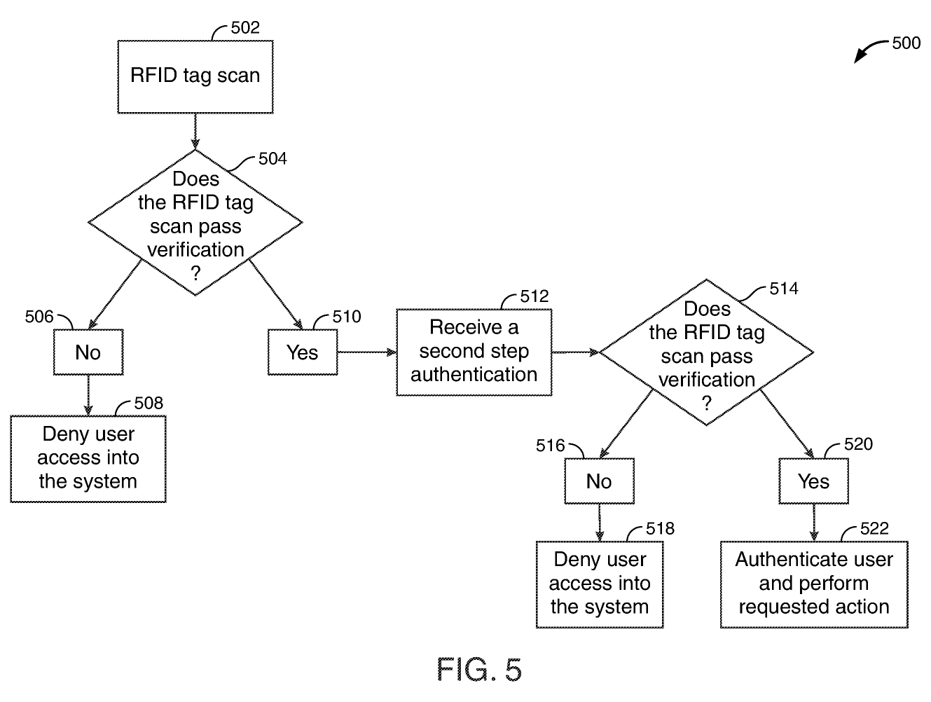

FIG. 5 shows process 500. Process 500 is the process that occurs when a user authenticates into a system. RFID tag scan 502 may be received at the system. As shown at step 504, the validity of the RFID tag scan may be compared to a stored RFID tag. If the scanned RFID tag does not match the stored RFID tag, RFID tag scan 502 may not pass verification, as shown at 506. In such an embodiment, the system may deny the user access to the system, as shown at 508. If the comparison between the scanned RFID tag and the stored RFID tag match, the RFID tag scan 502 may pass authentication, as shown at step 510. In such an embodiment, the system may receive a second step authentication, as shown at step 512.

Upon receiving the second step authentication, the second step authentication may be confirmed, as shown at step 514. Second step authentication may fail verification, as shown at step 516. In such an embodiment, the system may deny the user access into the system, as shown at step 518. Second step authentication may pass verification, as shown at step 520. In such an embodiment, the system may authenticate the user, as shown at step 522. The system may execute the selected action, as shown at step 522.

Thus, systems and methods for Radio Frequency Identification (“RFID”) tags used as an authentication token are provided. Persons skilled in the art may appreciate that the present invention can be practiced by other than the described embodiments, which are presented for purposes of illustration rather than of limitation. The present invention is limited only by the claims that follow.

What is claimed is:

1. A method for a two-step authentication process, the method comprising:
receiving a request from a user to authenticate into a system;
transmitting, from the system to a user’s mobile device, a request for a radio-frequency identification (“RFID”) tag scan;
transmitting a scan of the RFID tag to the system;
transmitting, from the system to the user’s mobile device, a request for a second step authentication;
receiving, at the user’s mobile device, a second step authentication to the system;
transmitting the second step authentication to the system;
receiving the second step authentication at the system; and
upon receiving the second step authentication at the system, determining at the system, if the RFID tag scan and the second step authentication achieve a predetermined level of authentication;
wherein, when the RFID tag scan and the second step authentication is determined to achieve the predetermined level of authentication, authenticating the user; and
wherein, when the RFID tag scan and the second step authentication is determined to fail to achieve the predetermined level of authentication, denying the user access into the system.

2. The method of claim 1 wherein the second step authentication comprises a personal identification number (“PIN”) entry.

3. The method of claim 1 wherein the second step authentication comprises a biometric scan.

4. The method of claim 1 wherein the second step authentication comprises a location of the user, as determined by a global positioning system (“GPS”) chip in the user’s mobile device.

5. The method of claim 1 wherein the second step authentication comprises a scan of a second RFID tag.

6. The method of claim 5 wherein a second RFID tag is specific to an action.

7. The method of claim 1 wherein a plurality of actions is executed upon authentication of the user with use of an RFID tag.

8. A system for authenticating a user, said authenticating using a two-step authentication process, the system operable to:
receive a request from a user’s mobile device to authenticate into the system;
receive a first step authentication, said first step authentication comprising a scan of a radio-frequency identification (“RFID”) tag;
receive a second step authentication; and
determine a predetermined level of authentication, wherein:
when the first step authentication and the second step authentication achieve the predetermined level of authentication, authenticating the user; and
when the first step authentication and the second step authentication achieve less than the predetermined level of authentication, denying the user access to the system.

9. The system of claim 8 wherein the second step authentication comprises a personal identification number (“PIN”) entry.

10. The system of claim 8 wherein the second step authentication comprises a biometric scan.

11. The system of claim 8 wherein the second step authentication comprises a location of the user, as determined by a global positioning system (“GPS”) chip in the user’s mobile device.

12. The system of claim 8 wherein the second step authentication comprises a scan of a second RFID tag.

13. The system of claim 12 wherein the second RFID tag is specific to an action.

14. The system of claim 8 wherein a plurality of actions is executed upon authentication of the user with use of an RFID tag.

15. A system for authenticating a user at a user’s device, said authenticating using a two-step authentication process, the system operable to:
transmit a request to the system to authenticate into a system;
receive a request for a first step authentication, said first step authentication comprising a scan of a radio-frequency identification (“RFID”) tag;
transmit a scan of the RFID tag to the system;
receive a request for a second step authentication;
transmit a second step authentication to the system;
based on the first step authentication and second step authentication, receiving:
when the first step authentication and the second step authentication achieve a predetermined level of authentication, authentication to enter the system; and
when the first step authentication and the second step authentication fail to achieve the predetermined level of authentication, denied access to the system.

16. The system of claim 15 wherein the second step authentication comprises a personal identification number (“PIN”) entry.

17. The system of claim 15 wherein the second step authentication comprises a biometric scan.

18. The system of claim 15 wherein the second step authentication comprises a location of the user, as determined by a global positioning system (“GPS”) chip in the user’s device.

19. The system of claim 15 wherein the second step authentication comprises a scan of a second RFID tag.

20. The system of claim 19 wherein the second RFID tag is specific to an action.

21. The system of claim 15 wherein a plurality of actions is executed upon authentication of the user with use of an RFID tag.
